(19) United States
(12) Patent Application Publication
(10) Pub. No.: US 2013/0136384 A1
(43) Pub. Date: May 30, 2013

(54) ROTARY TABLE FOR A MACHINE TOOL

(71) Applicant: Peter T.H. Tsai, Taipei City (TW)

(72) Inventor: Peter T.H. Tsai, Taipei City (TW)

(73) Assignee: ALEX-TECH MACHINERY INDUSTRIAL CO., LTD., Taichung City (TW)

(21) Appl. No.: 13/467,616

(22) Filed: May 9, 2012

(30) Foreign Application Priority Data
Nov. 24, 2011 (TW) 100143119

(51) Int. Cl. B23Q 1/52; F16C 17/12; F16C 33/02

(52) U.S. Cl. 384/322

(57) ABSTRACT

A rotary table includes a base unit having an upper surface that is formed with a lubricant groove adapted for passage of liquid lubricant, a table unit mounted rotatably on the base unit and having a lower surface, and a wear-resistant member covering the lower surface. A space is formed between the upper surface and the wear-resistant member for permitting flow of the liquid lubricant away from the lubricant groove through the space.

### CROSS-REFERENCE TO RELATED APPLICATION

This application claims priority of Taiwanese Application No. 100143119, filed on Nov. 24, 2011.

### BACKGROUND OF THE INVENTION

1. Field of the Invention

The invention relates to a rotary table, more particularly to a rotary table for a machine tool.

2. Description of the Related Art

A rotary table in a machine tool is operable for changing position of a workpiece fixed thereon relative to a cutting unit of the machine tool. Some rotary tables are even capable of different rotating movements so as to provide different cutting modes. Due to the large dimensions of the rotary table, use of high-precision bearings for assisting rotating movement of the rotary table may significantly increase the production cost. Therefore, a technique of coating a wear-resistant layer was developed for use in place of the high-precision bearings.

As shown in FIG. 1, a conventional rotary table 10 of a machine tool disclosed in Taiwanese Patent Publication No. I334370 includes a base 11 and a table 12. The base 11 has a supporting portion 111 on which a wear-resistant layer 112 is coated, wherein the wear-resistant layer 112 has a material selected from one of epoxy resin, fluoro-resin, diamond resin, and a combination thereof. The table 12 is mounted on the base 11, is rotatable about an axis (1), and has a bottom portion 121 having a portion in contact with the wear-resistant layer 112. During rotating movement of the rotary table 10, the wear-resistant layer 112 serves to reduce wear between the supporting portion 111 and the bottom portion 121.

However, such a configuration of the wear-resistant layer 112 may suffer from excess heat generated during operation, which may cause deformation of the base 11 and the table 12 and hence may have an adverse effect on accuracy of resultant workpieces.

### SUMMARY OF THE INVENTION

Therefore, the object of the present invention is to provide a rotary table having function of lubrication and heat-dissipation.

Accordingly, a rotary table of the present invention comprises:

a base unit having an upper surface that is formed with a lubricant groove adapted for passage of liquid lubricant;

a table unit mounted rotatably on the base unit, and having a lower surface; and

a wear-resistant member covering the lower surface; wherein a space is formed between the upper surface and the wear-resistant member for permitting flow of the liquid lubricant away from the lubricant groove through the space.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary sectional view of a conventional rotary table;

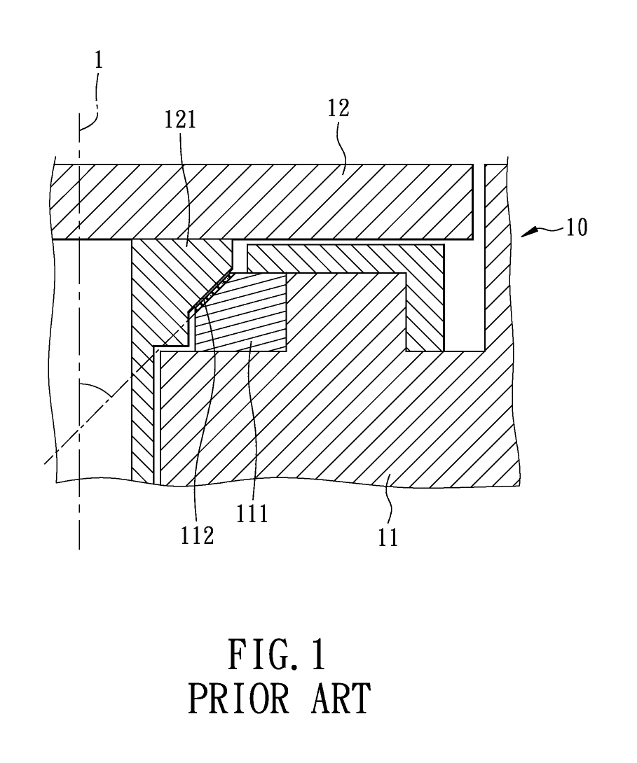

FIG. 2 is a fragmentary sectional view of a preferred embodiment of a rotary table according to the invention; and

FIG. 3 is an enlarged fragmentary sectional view of the preferred embodiment.

### DETAILED DESCRIPTION OF THE PREFERRED EMBODIMENT

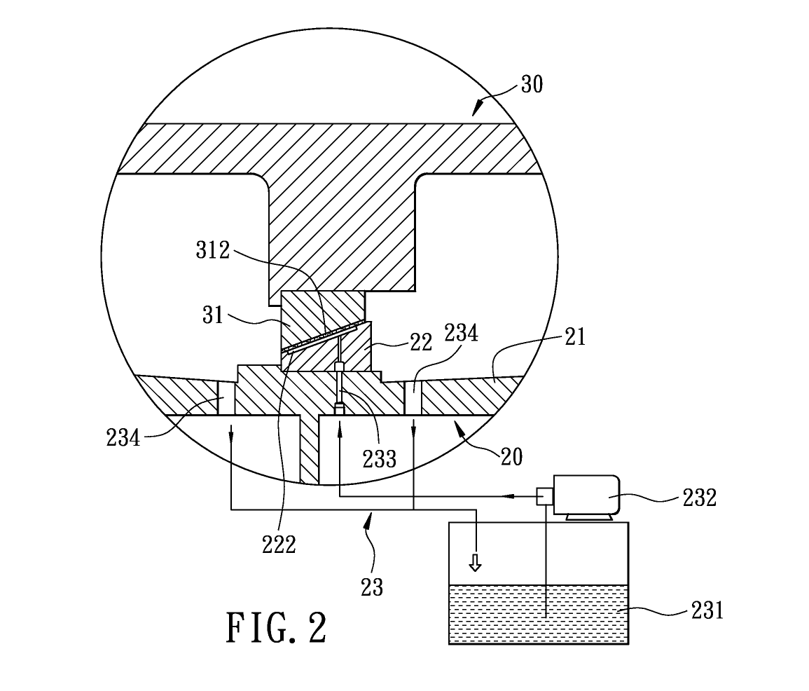

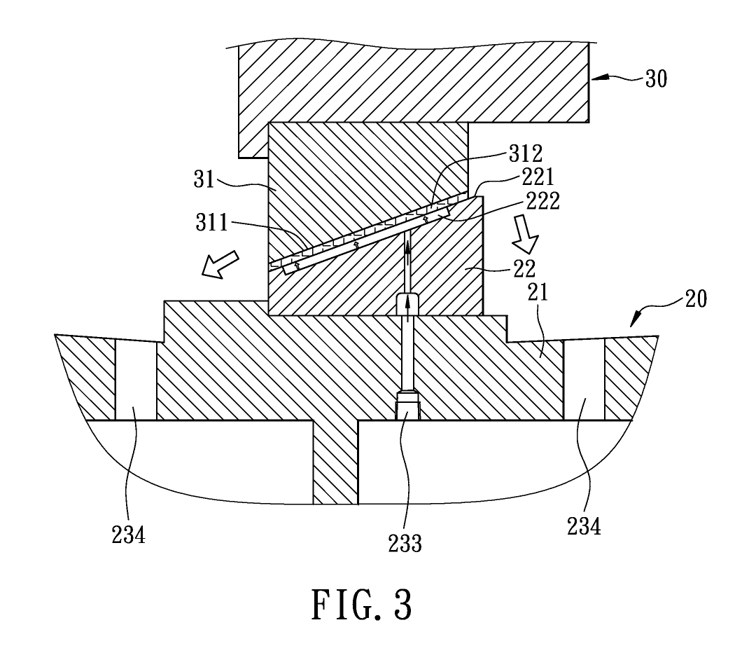

As shown in FIGS. 2 and 3, a preferred embodiment of a rotary table for a machine tool (not shown) according to the present invention comprises a base unit 20, a table unit 30 that is mounted rotatably on the base unit 20, and a liquid circulating system 23.

The base unit 20 includes a main portion 21 and a supporting portion 22 extending upwardly from the main portion 21. The supporting portion 22 has an upper surface 221 that is sloped to form a predetermined angle with horizontal, and that is formed with a lubricant groove 222 adapted for receiving liquid lubricant.

The table unit 30 includes a lower portion 31 having a sloped lower surface 311 supported rotatably by the supporting portion 22 of the base unit 20. The rotary table further comprises a wear-resistant member 312 covering the lower surface 311. In this embodiment, the wear-resistant member 312 may be made from epoxy resin, fluoro-resin, or diamond resin.

The rotary table further comprises a liquid circulating system 23 that includes a tank 231, a first conduit 233 extended through the supporting portion 22 of the base unit 20 toward the upper surface 221, a pump 232 fluidly connecting the tank 231 to the first conduit 233, and a pair of second conduits 234 extending through the main portion 21 of the base unit 20 at opposite sides of the supporting portion 22 and fluidly communicating the tank 231.

The liquid lubricant is initially stored in the tank 231. During operation of the rotary table of this invention, the liquid lubricant is drawn by the pump 232 out of the tank 231 and introduced into the lubricant groove 222 via the first conduit 233. As the liquid lubricant is continuously drawn from the tank 231 into the lubricant groove 222, the overflowed lubricant flows away from the lubricant groove 222 through a space that is defined between the upper surface 221 and the wear-resistant member 312 for reducing friction therebetween and carrying away heat that is generated from the rotating movement of the table unit 30 relative to the base unit 20. Additionally, the sloped upper surface 221 of the base unit 20 and the lower surface 311 of the table unit 30 further facilitates the flow of the lubricant out of the lubricant groove 222. Finally, the lubricant exits the space flows back to the tank 231 via the second conduits 234 for completing the circulation of the lubricant, and the heat is dissipated by virtue of the circulation of the lubricant.

It is noted that in the rotating movement of the rotary table, the wear-resistant member 312 effectively reduces the wear between the supporting portion 22 and the lower portion 31, and by virtue of the liquid circulating system 23, the rotating movement is lubricated and the heat generated therein is successfully dissipated. Thus, the machine tool with the rotary table of the preferred embodiment has a longer service life and the machining accuracy thereof is not adversely affected.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A rotary table for a machine tool, comprising:
a base unit having an upper surface that is formed with a lubricant groove adapted for passage of liquid lubricant;
a table unit mounted rotatably on said base unit, and having a lower surface; and
a wear-resistant member covering said lower surface;
wherein a space is formed between said upper surface and said wear-resistant member for permitting flow of the liquid lubricant away from said lubricant groove through said space.

2. The rotary table as claimed in claim 1, further comprising a liquid circulating system that includes
a tank adapted for storing the liquid lubricant,
a first conduit extended through said base unit toward said upper surface,
a pump fluidly connecting said tank to said first conduit, and operable for pumping the liquid lubricant from said tank into said lubricant groove via said first conduit, and
a second conduit in fluid communication with said tank, and adapted for permitting flow of the liquid lubricant from said space into said tank.

3. The rotary table as claimed in claim 1, wherein said upper surface of said base unit is sloped, and forms a predetermined angle with horizontal.
